(19) United States
(12) Patent Application Publication
(10) Pub. No.: US 2018/0070327 A1
(43) Pub. Date: Mar. 8, 2018

(54) System and Methods for Performing an Early Radio Link Recovery Procedure on a Multi-Subscriber Identity Module Wireless Communication Device

(71) Applicant: QUALCOMM Incorporated, San Diego, CA (US)

(72) Inventors: Muhammad Umair Qureshi, Frankfurt am main (DE); Penchal Prasad Goddeti, Sulzbach (DE); Deepesh Garg, Schwalbach am Taunus (DE); Deepak Shastry Ravishankar, Frankfurt (DE)

(21) Appl. No.: 15/257,410

(22) Filed: Sep. 6, 2016

(51) Int. Cl. H04W 56/00; H04L 29/06; H04W 76/04; H04W 74/00

(52) U.S. Cl. CPC H04W 56/0055; H04L 63/0853; H04W 88/06; H04L 69/28; H04W 74/006; H04W 76/046

(57) ABSTRACT

A wireless communication device may have at least a first subscriber identification module (SIM) and a second SIM associated with a shared radio frequency (RF) resource. The wireless communication device may determine whether some or all of a critical radio resource control (RRC) control message from a first network supported by the first SIM was missed during a tune-away. In response to determining that some or all of a critical RRC control message was missed during the tune-away, the wireless communication device may start a downlink expiration timer, determine whether the downlink expiration timer has expired without receiving sufficient information to complete the critical RRC control message. If so, and if the modem stack associated with the first SIM has lost downlink synchronization with the first network for a number of consecutive radio frames, the wireless communication device may declare a radio link failure for that SIM.

### BACKGROUND

Multi Wireless communication devices that can operate with more than one subscriber identity module (SIM) have become increasing popular because of their flexibility in service options and other features. One type of multi-SIM wireless communication device, a multi-SIM multi-standby (MSMS) device (e.g., a dual-SIM dual-standby (DSDS) device), enables two SIMs to be in idle mode waiting to begin communications, but only allows one SIM at a time to participate in an active communication due to sharing of a radio frequency (RF) resource (e.g., an RF transceiver). Other multi-SIM devices may extend this capability to more than two SIMs and may be configured with any number of SIMs greater than two (i.e., multi-SIM multi-standby wireless communication devices).

Wireless communication networks (referred to simply as “wireless networks”) are widely deployed to provide various communication services such as voice, packet data, broadcast, messaging, etc. Wireless networks may be capable of supporting communication for multiple users by sharing the available network resources. Such sharing of available network resources may be implemented by networks using one or more multiple-access wireless communications protocols, such as Time Division Multiple Access (TDMA), Code Division Multiple Access (CDMA), Time Division Multiple Access (TDMA), and Frequency Division Multiple Access (FDMA). These wireless networks may also utilize various radio technologies, including but not limited to Global System for Mobile Communications (GSM), Universal Mobile Telecommunications System (UMTS), High Speed Packet Access (HSPA) is CDMA2000, Advanced Mobile Phone Service (AMPS), General Packet Radio Services (GPRS), Long Term Evolution (LTE), High Data Rate (HDR) technology (e.g., 1×EV technology), etc.

A MSMS wireless communication device typically shares a RF resource among two or more subscriptions, actively communicating for a single SIM or subscription with an associated network at a given time. Therefore, during an active data call on one SIM (e.g., the first SIM), the wireless communication device periodically tunes the shared RF resource away from a first wireless network associated with a first SIM to another wireless network associated with another SIM (e.g., the second SIM) to monitor signals or acquire a connection. As a result, depending on the duration of the tune away, the network supported by the first SIM may transmit downlink messages for which some or all of the data is not received by the wireless communication device. In particular, such a downlink message may inform the device of critical configuration changes. Therefore, failure to receive the complete message before a corresponding configuration change is implemented by the network may cause a mismatch between the device and the network, leading to a loss of synchronization in the physical layer.

### SUMMARY

Systems, methods, and devices of various embodiments may improve performance of a multi-subscriber identification module (MSIM) wireless communication device having at least a first SIM and a second SIM associated with a shared radio frequency (RF) resource. Various embodiments may include determining whether some or all of a critical radio resource control (RRC) control message from a first network supported by the first SIM was missed during a tune-away from an active data call on a modem stack associated with the first SIM to a second network supported by the second SIM. Various embodiments may further include, in response to determining that some or all of a critical RRC control message from the first network was missed during the tune-away, starting a downlink expiration timer, determining whether the downlink expiration timer has expired without receiving sufficient information to complete the critical RRC control message, determining whether the modem stack associated with the first SIM has lost downlink synchronization with the first network for a selected number of consecutive radio frames, and declaring a radio link failure on the modem stack associated with the first SIM in response to determining that the downlink expiration timer has expired without receiving sufficient information to complete the critical RRC control message, and that the modem stack associated with the first SIM has lost downlink synchronization with the first network for the selected number of consecutive radio frames.

In some embodiments, determining whether some or all of a critical RRC control message from the first network was missed during the tune-away may include detecting that at least one downlink radio link control (RLC) packet data unit (PDU) was missed during the tune-away based on one or more out-of-sequence RLC PDUs received on the modem stack associated with the first SIM after the tune-away, sending a status report message to the first network, identifying, among downlink RLC PDUs received on the modem stack associated with the first SIM, a first RLC PDU of a new RLC service data unit (SDU), and determining an RRC message type of the new RLC SDU based on a syntax of the identified first RLC PDU. In some embodiments, the at least one missed downlink RLC PDU may be retransmitted by the first network based on the status report message.

In some embodiments, identifying the first RLC PDU of a new RLC service data unit (SDU) may include detecting an RLC header containing a special length indicator in a downlink RLC PDU received from the first network. In some embodiments, determining whether the modem stack associated with the first SIM has lost downlink synchronization with the first network for a selected number of consecutive radio frames may include determining whether a downlink out-of-sync indicator is successively detected in a physical layer of the modem stack associated with the first SIM for the selected number of radio frames.

Some embodiments may further include determining whether a downlink RLC PDU is received while the downlink expiration timer is running, determining whether sufficient information has been received to complete the critical RRC control message for the modem stack associated with the first SIM in response to determining that a downlink RLC PDU is received while the downlink expiration timer is running, and restarting the downlink expiration timer in response to determining that sufficient information has not been received to complete the critical RRC control message.

Some embodiments may further include maintaining a current radio link configuration in response to determining that the modem stack associated with the first SIM has not lost downlink synchronization with the first network for the selected number of radio frames.

Some embodiments may further include performing a cell update procedure to reestablish the active data call with the first network in response to determining that the downlink expiration timer has expired without receiving sufficient information to complete the critical RRC control message, and that the modem stack associated with the first SIM has lost downlink synchronization with the first network for the selected number of radio frames. In some embodiments, a duration of the selected number of consecutive radio frames may be around 0.5 seconds. In some embodiments, the downlink expiration timer may have a duration of around 2.56 seconds.

Various embodiments include a wireless communication device configured to use at least two SIMs associated with a shared RF resource, and including a processor configured with processor-executable instructions to perform operations of the methods summarized above. Various embodiments also include a non-transitory processor-readable medium on which is stored processor-executable instructions configured to cause a processor of a wireless communication device to perform operations of the methods summarized above. Various embodiments also include a wireless communication device having means for performing functions of the methods summarized above.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a communication system block diagram of a network suitable for use with various examples.

FIG. 2 is a block diagram illustrating a wireless communications device according to various examples.

FIG. 3 is a system architecture diagram illustrating example protocol layer stacks implemented by the wireless communication device of FIG. 2.

FIGS. 4A and 4B are process flow diagrams illustrating an example method for implementing an early radio link recovery procedure for an active data call on a multi-SIM wireless communication device according to various embodiments.

FIG. 5 is a component diagram of an example wireless communication device suitable for use with various examples.

FIG. 6 is a component diagram of another example wireless communication device suitable for use with various examples.

### DETAILED DESCRIPTION

Various examples will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

Normal RF resource arbitration may be employed to schedule use of a shared RF resource between SIMs on a MSMS wireless communication device. While such sharing may be limited to transmit and/or receive functions, in some MSMS wireless communication devices the sharing may extend to functions associated with a baseband-modem processor. Examples of baseband-modem processor functions that may be shared depend on the particular access technology, but can include downlink/uplink common channel processing, downlink/uplink common signal processing, receive/transmit signal processing, etc.

In an MSMS device in which the shared RF resource is used for an active communication on a first SIM, a second SIM may be in an idle mode and not actively contending for access to the RF resource. However, the MSMS device may maintain a connection with a serving network associated with the second SIM by performing limited communication activities (i.e., “idle mode tasks”). Depending on the communication protocol, examples of idle mode activities may include receiving system information, decoding a paging channel, measuring signal strength of neighbor cells, etc. Performing idle mode tasks for the second SIM during an active data call connection for the first SIM may involve implementing discontinuous reception (DRX) on the second SIM. In an “awake” period of the DRX cycle, the shared RF resource may tune away from the communication on the first SIM and tune to the network supporting the subscription enabled by the second SIM to perform idle mode activities, followed by tuning back to the communication on the first SIM. However, if the duration of such tune-away period is long, the MSMS device may experience a radio link failure for the active data call on the first SIM.

During a tune-away from an active data communication on a WCDMA-enabled SIM, control signaling from the network instructing the wireless communication device to implement a new configuration may be missed. As a result, the existing configurations on the wireless communication device may become mismatched with respect to the updated configurations on the network. Therefore, the wireless communication device may lose physical layer synchronization with the network, causing a radio link failure after expiration of a wait time. Such loss of synchronization may be cured by declaring a radio link failure on the wireless communication device, and performing a cell update procedure that reestablishes the active data call. However, such procedures are inefficient since the radio link failure is not triggered until a wait time after the loss of synchronization. The wait time to trigger the radio link failure may be an unnecessary delay to regaining synchronization with the network for data call reestablishment, thereby degrading performance of the wireless communication device.

Various embodiments provide methods, systems, and devices that improve performance of MSMS wireless communication devices by avoiding unnecessary delay in recovering service with a new network configuration by prompting an early radio link failure to be declared on the first SIM. In various embodiments, the wireless communication device may determine whether conditions are satisfied that indicate that some or all of an RRC configuration message was missed during the tune-away to a network associated with another SIM. For example, following a tune-away to a different network, the wireless communication device may declare radio link failure upon determining that some or all of a critical RRC signaling message was missed from a network associated with the first SIM, that a selected amount of time has expired since downlink information was received, and that a loss of synchronization with the network in the physical layer is detected for a selected number of consecutive radio frames.

The term “wireless communication device” is used herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “subscription,” “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless communication device on a network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM.

The terms “subscription” and “SIM” may also be used as shorthand reference to a communication network associated with a particular SIM, since the information stored in a SIM enables the wireless communication device to establish a communication link with a particular network, thus the SIM and the communication network, as well as the services and subscriptions supported by that network, correlate to one another.

As used herein, the terms “multi-SIM wireless communication device,” “multi-SIM wireless communication device,” “MSMS device,” “dual-SIM wireless communication device,” “dual-SIM dual-standby device,” and “DSDS device” are used interchangeably to describe a wireless communication device that is configured with more than one SIM and allows idle-mode operations to be performed on two networks simultaneously, as well as selective communication on one network while performing idle-mode operations on the other network.

As used herein, the terms “power-saving mode,” “power-saving-mode cycle,” “discontinuous reception,” and “DRX cycle” are used interchangeably to refer to an idle-mode process that involves alternating sleep periods (during which power consumption is minimized) and awake (or “wake-up”) periods (in which normal power consumption and reception are returned and the wireless communication device monitors a channel by normal reception). The length of a power-saving-mode cycle, measured as the interval between the start of a wake-up period and the start of the next wake-up period, is typically signaled by the network.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports a number of air interface standards, such as Wideband-Code Division Multiple Access (WCDMA), Time Division—Code Division Multiple Access (TD-CDMA), and Time Division—Synchronous Code Division Multiple Access (TD-SCDMA). The UMTS also includes enhanced 3G data communications protocols, such as High Speed Packet Access (HSPA), which provides higher data transfer speeds and capacity to associated UMTS networks. As used herein, the terms “UNITS” and “WCDMA” may be used interchangeably to refer to any network that uses UMTS radio technology. However, such references are provided merely as examples, and are not intended to exclude wireless networks that use other communication standards.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks such as CDMA, time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including WCDMA standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers Normal RF resource arbitration may be employed to schedule use of a shared RF resource between SIMs on a MSMS wireless communication device. While such sharing may be limited to transmit and/or receive functions, in some MSMS wireless communication devices the sharing may extend to functions associated with a baseband-modem processor. Examples of baseband-modem processor functions that may be shared depend on the particular access technology, but can include downlink/uplink common channel processing, downlink/uplink common signal processing, receive/transmit signal processing, etc.

References to “first” and “second” SIMs, subscriptions and networks herein are arbitrary and used merely for convenience in describing various embodiments. As a matter of convenience, a subscription associated with a SIM that is in an active data communication session on a network is referred to as the “first subscription” or the “first SIM” communicating on a “first network,” while all other subscriptions and SIMs (i.e., subscriptions/SIMs performing tune-aways to another network) are referred to as a “second subscription” and “second SIM” communicating with an associated “second network.” Thus, references to first and second SIMs are not intended to limit the scope of the claims to only two SIMs as various embodiments also apply to multi-SIM wireless communication device supporting three or more SIMs. Further, references to “first SIM” and “second SIM” are intended to be limited to temporary conditions of a particular active communication session, because at a later point in time a subscription that was previously in an idle mode may commence an active communication session causing a subscription that was previously active to enter the idle mode. The multi-SIM wireless communication device processor may assign any indicator, name or other designation to differentiate the one or more SIM and associated modem stacks. While various embodiments may be described with respect to WCDMA, such embodiments but may be extended to other telecommunication standards employing other modulation and multiple access techniques.

In some wireless networks, a wireless communication device may have multiple subscriptions to one or more networks (e.g., by employing multiple SIM cards or otherwise). Such a wireless communication device may include, but is not limited to, a DSDS device. For example, a first subscription may be a first technology standard, such as WCDMA, while a second subscription may support the same technology standard or a second technology standard. For clarity, while the techniques and embodiments described herein relate to a wireless device configured with at least one WCDMA/UMTS SIM and/or GSM SIM, the embodiment techniques may be extended to subscriptions on other radio access networks (e.g., 1xRTT/CDMA2000, EVDO, LTE, WiMAX, Wi-Fi, etc.). In that regard, the messages, physical and transport channels, radio control states, etc. referred to herein may also be known by other terms in various radio access technologies and standards. Further, the messages, channels and control states may be associated with different timing in other radio access technologies and standards.

In various embodiments, an RF resource of an MSMS device (e.g., a DSDS device) may be configured to be shared between a plurality of SIMs, but may be employed by default to perform communications on a network enabled by a first SIM, such as a network capable of data communications (e.g., WCDMA, HSDPA, LTE, etc.). As such, a modem stack associated with a second SIM of the device may often be in idle mode with respect to a second network. Depending on the radio access technology of the second network, such idle mode may involve implementing a power saving mode that includes a cycle of sleep and awake states. For example, if the second network is a GSM network, during idle mode the modem stack associated with the second SIM may implement DRX.

The timing of a wake-up period (i.e., awake state) may be set by the second network for a paging group to which the second SIM belongs. The modem stack associated with the second SIM may attempt to use the shared RF resource to decode a paging channel of the second network to receive paging messages. During the sleep state, the modem stack may power off most processes and components, including the associated RF resource. In some networks, such as GSM networks, the duration of time in the wake-up period in which a paging message may be received (i.e., duration of a paging occasion) is around 6 ms. Similarly, the paging cycle (e.g., the interval between the start of consecutively scheduled page decode/monitoring times) in a GSM network may typically be 470 ms.

In an active data call on a wireless communication device using WCDMA, data may be exchanged between the wireless communication device (or modem stack associated with a SIM of the wireless communication device) based on a timing pattern for radio frames that have a duration of 10 ms. Data transmitted in a radio frame may be referred to as a transport block.

Data generated at higher layers in the UNITS protocol stack is carried over the air with transport channels, which are mapped in the physical layer to different physical channels. The dedicated channel (DCH) is mapped onto two physical channels. The Dedicated Physical Data Channel (DPDCH) carries higher layer information, including user data, while the Dedicated Physical Control Channel (DPCCH) carries the necessary physical layer control information. UTRA channels use a 10 ms radio frame structure. For procedures that span more than a single frame (e.g., paging procedure and random access procedure) a system frame number (SFN) may be used.

Control signaling between a wireless communication device and UTRAN is provided primarily through radio resource control (RRC) messages. RRC messages carry parameters required to setup, modify, and release lower layer protocol entities. The control interfaces between the RRC and all the lower layer protocols are used to configure characteristics of the lower layer protocol entities, including parameters for the physical, transport and logical channels. To cause a wireless communication device to change its configuration, a network may issue a message with instructions to invoke a specific RRC procedure. Some such procedures involve corresponding configuration changes in the network, and therefore the reception of such RRC control messages is critical to maintaining or establishing synchronization with the network.

For clarity, while the techniques and examples described herein relate to a wireless communication device configured with at least one WCDMA/UMTS SIM and/or GSM SIM, the example techniques may be extended to subscriptions on other radio access networks (e.g., 1xRTT/CDMA2000, EVDO, LTE, WiMAX, Wi-Fi, etc.). In that regard, the messages, physical and transport channels, radio control states, etc. referred to herein may also be known by other terms in various radio access technologies and standards. Further, the messages, channels and control states may be associated with different timing in other radio access technologies and standards.

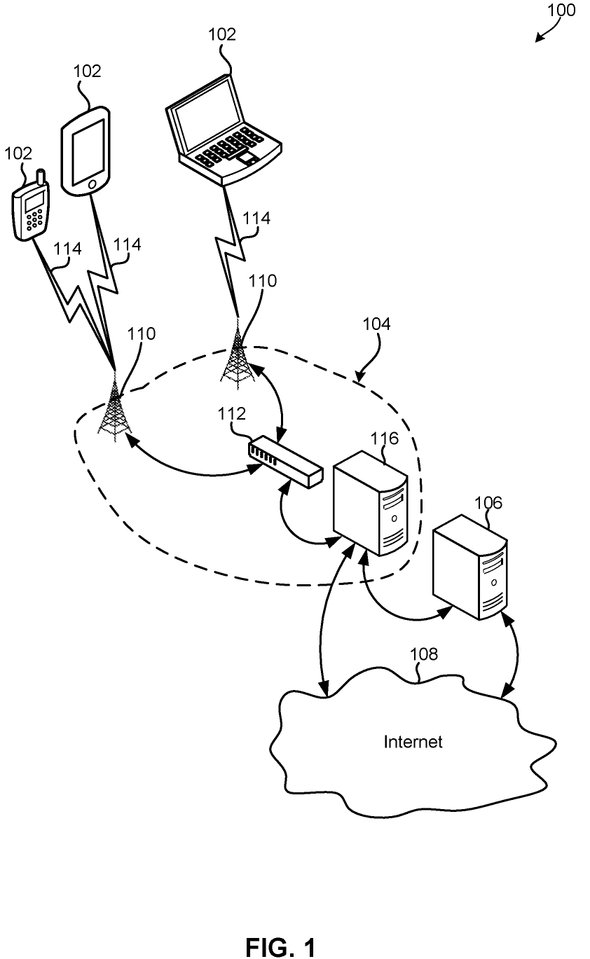

Various examples may be implemented within a variety of communication systems, such as the example communication system 100 illustrated in FIG. 1. The communication system 100 may include one or more wireless communication devices 102, a telephone network 104, and network servers 106 coupled to the telephone network 104 and to the Internet 108. In some examples, the network server 106 may be implemented as a server within the network infrastructure of the telephone network 104.

A typical telephone network 104 includes a plurality of cell base stations 110 coupled to a network operations center 112, which operates to connect voice and data calls between the wireless communication devices 102 (e.g., tablets, laptops, cellular phones, etc.) and other network destinations, such as via telephone land lines (e.g., a plain old telephone system (POTS) network, not shown) and the Internet 108. The telephone network 104 may also include one or more servers 116 coupled to or within the network operations center 112 that provide a connection to the Internet 108 and/or to the network servers 106. Communications between the wireless communication devices 102 and the telephone network 104 may be accomplished via two-way wireless communication links 114, such as GSM, UMTS, EDGE, 4G, 3G, CDMA, TDMA, LTE, and/or other communication technologies.

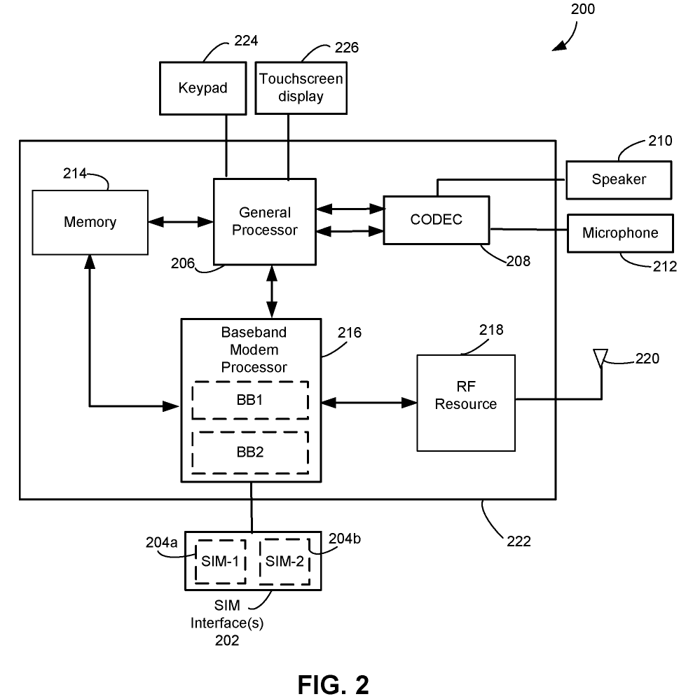

FIG. 2 is a functional block diagram of an example wireless communication device 200 that is suitable for implementing various examples. The example wireless communication device 200 may be similar to one or more of the wireless communication devices 102 described with reference to FIG. 1. With reference to FIGS. 1-2, the wireless communication device 200 may be a multi-SIM device, such as a dual-SIM device. In an example, the wireless communication device 200 may be a dual-SIM dual-standby (DSDS) device. The wireless communication device 200 may include at least one SIM interface 202, which may receive a first SIM (SIM-1) 204a that is associated with a first subscription. In some examples, the at least one SIM interface 202 may be implemented as multiple SIM interfaces 202, which may receive at least a second SIM (SIM-2) 204b that is associated with at least a second subscription.

A SIM in various examples may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various examples may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a home public land mobile network (HPLMN) code, etc.) to indicate the SIM network operator provider. An Integrated Circuit Card Identity (ICCID) SIM serial number may be printed on one or more SIM 204 for identification.

The wireless communication device 200 may include at least one controller, such as a general-purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to a subscription though a corresponding baseband-RF resource chain. The memory 214 may store operating system (OS), as well as user application software and executable instructions.

The general purpose processor 206 and memory 214 may each be coupled to at least one baseband-modem processor 216. Each SIM 204a, 204b in the wireless communication device 200 may be associated with a baseband-RF resource chain that includes at least one baseband-modem processor 216 and at least one RF resource 218. In some examples, the wireless communication device 200 may be a DSDS device, with both SIMs 204a, 204b sharing a single baseband-RF resource chain that includes the baseband-modem processor 216 and RF resource 218. In some examples, the shared baseband-RF resource chain may include, for each of the first SIM 204a and the second SIM 204b, separate baseband-modem processor 216 functionality (e.g., BB1 and BB2). The RF resource 218 may be coupled to at least one antenna 220, and may perform transmit/receive functions for the wireless services associated with each SIM 204a, 204b of the wireless communication device 200. The RF resource 218 may implement separate transmit and receive functionalities, or may include a transceiver that combines transmitter and receiver functions.

In some examples, the general purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless communication device 200 may include, but are not limited to, a keypad 224 and a touchscreen display 226.

In some examples, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software and functions in the wireless communication device 200 to enable communication between them, as is known in the art.

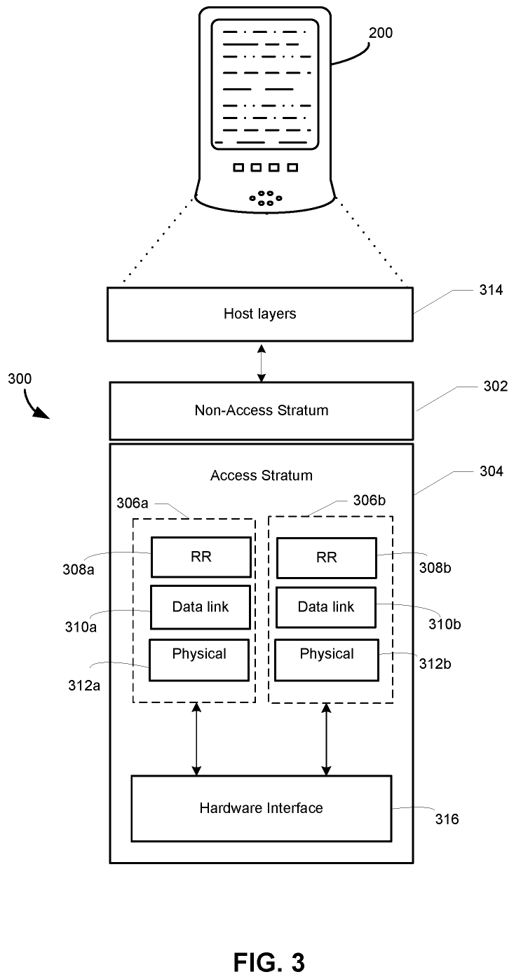

Referring to FIGS. 1-3, wireless communication device 200 may have a layered software architecture 300 to communicate over access networks associated with SIMs. The software architecture 300 may be distributed among one or more processors, such as baseband-modem processor 216. The software architecture 300 may also include a Non Access Stratum (NAS) 302 and an Access Stratum (AS) 304. The NAS 302 may include functions and protocols to support traffic and signaling between SIMs of the wireless communication device 200 (e.g., first SIM/SIM-1 204a, second SIM/SIM-2 204b) and their respective core networks. The AS 304 may include functions and protocols that support communication between the SIMs (e.g., first SIM 204a, second SIM 204b) and entities of their respective access networks (such as a mobile switching center (MSC) if in a GSM network).

In the multi-SIM wireless communication device 200, the AS 304 may include multiple protocol stacks, each of which may be associated with a different SIM. For example, the AS 304 may include protocol stacks 306a, 306b, associated with the first and second SIMs 204a, 204b, respectively. Although described below with reference to GSM-type communication layers, protocol stacks 306a, 306b may support any of variety of standards and protocols for wireless communications.

Each protocol stack 306a, 306b may respectively include Radio Resource management (RR) layers 308a, 308b. The RR layers 308a, 308b may be implementations of the radio resource control (RRC) layer of a UMTS signaling protocol, or part of Layer 3 of a GSM signaling protocol. The RR layers 308a, 308b may oversee the establishment of a link between the wireless communication device 200 and associated access networks. In the various examples, the NAS 302 and RR layers 308a, 308b may perform the various functions to search for wireless networks and to establish, maintain and terminate calls.

In some examples, each RR layer 308a, 308b may be one of a number of sub-layers of Layer 3. Other sub-layers may include, for example, connection management (CM) sub-layers (not shown) that route calls, select a service type, prioritize data, perform QoS functions, etc.

Residing below the RR layers 308a, 308b, the protocol stacks 306a, 306b may also include data link layers 310a, 310b, which may be part of Layer 2 in a UMTS or GSM signaling protocol. The data link layers 310a, 310b may provide functions to handle incoming and outgoing data across the network, such as dividing output data into data frames and analyzing incoming data to ensure the data has been successfully received. In some examples, each data link layer 310a, 310b may contain various sub-layers (e.g., media access control (MAC) and radio link control (RLC) sublayers (not shown)). Residing below the data link layers 310a, 310b, the protocol stacks 306a, 306b may also include physical layers 312a, 312b, which may establish connections over the air interface and manage network resources for the wireless communication device 200.

While the protocol stacks 306a, 306b provide functions to transmit data through physical media, the software architecture 300 may further include at least one host layer 314 to provide data transfer services to various applications in the wireless communication device 200. In some examples, application-specific functions provided by the at least one host layer 314 may provide an interface between the protocol stacks 306a, 306b and the general processor 206. In alternative examples, the protocol stacks 306a, 306b may each include one or more higher logical layers (e.g., transport, session, presentation, application, etc.) that provide host layer functions. In some examples, the software architecture 300 may further include in the AS 304 a hardware interface 316 between the physical layers 312a, 312b and the communication hardware (e.g., one or more RF resource).

In various examples, the protocol stacks 306a, 306b of the layered software architecture may be implemented to allow modem operation using information provisioned on multiple SIMs. Therefore, a protocol stack that may be executed by a baseband-modem processor is interchangeably referred to herein as a modem stack.

The modem stacks in various embodiments may support any of a variety of current and/or future protocols for wireless communications. For examples, the modem stacks in various examples may support networks using other radio access technologies described in 3GPP standards (e.g., Long Term Evolution (LTE), etc.), 3GPP2 standards (e.g., 1xRTT/CDMA2000, Evolved Data Optimized (EVDO), Ultra Mobile Broadband (UMB), etc.) and/or Institute of Electrical and Electronics Engineers (IEEE) standards Worldwide Interoperability for Microwave Access (WiMAX), Wi-Fi, etc.).

While access to a WCDMA network may be referred to herein with respect to the first SIM of the wireless device, it will be understood that network access procedures are performed on a modem stack associated with an IMSI (i.e., SIM) in the UMTS system. That is, reference to the wireless communication device in various procedures and/or communications with a network may be a general reference to the user equipment associated with a subscription in the network. As such, a SIM transferred to different user equipment may be characterized as the same wireless communication device for purposes of network connections.

A wireless communication device may access a network (i.e., UTRAN) by connecting to a serving cell. Such connecting generally involves cell search and cell selection, derivation of system information, and performing an access procedure initiated using random access.

In particular, once powered on and/or recovering from an out-of-service condition, a wireless communication device may begin an initial cell selection procedure in a WCDMA network if no information about the current wireless environment is stored in the wireless communication device. The wireless communication device may have stored the necessary information of the previous serving cell in the network, such as frequency and scrambling code. Generally, the wireless communication device may first try to synchronize with that previous cell, and if synchronization fails, the wireless communication device may trigger the initial cell selection. Otherwise, the wireless communication device may start a cell selection using a stored information cell-selection procedure.

The wireless communication device may first attempt to find public land mobile networks (PLMNs) for one or more radio access technology. To find PLMNs, the wireless communication device may perform a power scan on enabled frequency bands supported by the radio access technology to identify channels and measure signal strength for identified channels. The wireless communication device may identify those channels that are above a threshold signal strength and may attempt acquisition of each identified strong channel. Acquisition of a UMTS channel may involve detecting a carrier frequency by searching for a primary synchronization code (PSC) sequence sent on a primary synchronization channel (SCH) for an identified strong channel, such as by correlating received samples with a locally generated PSC sequence at different time offsets. Alternatively, the wireless communication device may use a list of stored carrier frequency information from previously received measurement and control information. In UMTS systems, such information includes scrambling code.

For each detected carrier frequency (i.e., acquired cell), the wireless communication device typically tunes to the frequency to read information to identify the associated network. For example, in UMTS systems, the wireless communication device typically correlates the signal of the detected carrier frequency (i.e., acquired cell) to possible secondary synchronization codes to determine the correct code. The wireless communication device then obtains the frame synchronization on the corresponding secondary synchronization channel (S-SCH) and group identity, finding the correct scrambling code, and detecting the common control physical channel (CCPCH), which carries the system information including the PLMN. In this manner, the wireless communication device may identify acquired cells in its vicinity, from which a cell may be selected for camping. In particular, the device may find a suitable cell by finding a cell that transmits power strong enough to be detected by the wireless communication device (based on values decoded from SIB), that is not barred, and that has a PLMN matching that of a selected PLMN.

In this manner, the wireless communication device may camp on a serving cell, and transition between two states/modes defined by the RRC protocol: RRC idle mode, and RRC connected mode. In the RRC idle mode, the wireless communication device is not known in the network, but may receive broadcast system information and data, decode a paging channel to detect incoming calls, perform neighbor cell measurements, and perform cell reselections. In the RRC connected mode, the wireless communication device may be able to transmit data to and receive data from the network by an RRC connection established with a serving NodeB that handles mobility and handovers.

Operations in the connected mode may be categorized as different service states based on the kind of physical channels being used. Specifically, in the Cell_DCH state, a dedicated physical channel is allocated to the wireless communication device, and the wireless communication device is known by its serving network on a cell or active set level. When sending or receiving moderate or large amounts of data, the wireless communication device typically stays in Cell_DCH state but is moved away from the Cell_DCH state once the data runs out.

In the Cell_DCH state, the wireless communication device may estimate uplink and downlink quality using several indices. For example, the wireless communication device may measure downlink block error rate (BLER), downlink and uplink signal-to-interference, transmit power control, uplink transmit power, etc.

In addition, the network and wireless communication device also constantly monitor the uplink and downlink dedicated channels for synchronization of radio links through synchronization primitives. For example, the wireless communication device may check for each frame, whether the downlink DPCCH over the previous 160 ms is worse than the downlink signal-to-interference, or all of the last 20 transport blocks received have cyclic redundancy check (CRC) errors. If either or both is found, then an out-of-sync primitive may supply an out-of-sync indicator to higher layers. Once an out-of-sync indicator is detected for a threshold number (N313) of radio frames, the wireless communication device may start a timer with a selected value (T313). Upon expiration of the timer, the wireless communication device may declare a radio link failure. In various embodiments, N313 and T313 values may be configured by the network, and broadcast in system information. For example, the threshold number N313 may be set to 200 frames (e.g., 2 seconds in WCDMA), while the timer T313 may be set to the time duration of 300 frames (e.g., 3 seconds in WCDMA).

When a serving network seeks to implement a configuration that requires updating a configuration in the wireless communication device, the network may send a downlink message (e.g., an RRC control message) containing instructions to invoke a specific RRC procedure. Examples of such RRC procedures may include, for example, a radio bearer setup, radio bearer reconfiguration, radio bearer release, transport channel reconfiguration, physical channel reconfiguration, etc. In some systems, a radio bearer setup procedure may establish a new radio bearer, and may provide an assignment of RLC parameters, assignment of a physical channel(s) and change of the used transport channel types, among other processes.

In a radio bearer release procedure, the RLC entity for the radio bearer may be released, as well as the DCH. Further, radio bearer release may involve, for example, the release of physical channel(s) and changing the used transport channel types. A radio bearer reconfiguration procedure may be implemented to change a signaling link to reflect a change in quality of service on the network. For example, the radio bearer reconfiguration procedure may include changing RLC parameters, assignment or release of physical channel(s) and change of used transport channel types, among other processes. A transport channel reconfiguration procedure may be performed to reconfigure parameters related to a transport channel. The transport channel reconfiguration may change physical channel parameters to reflect a reconfiguration of a transport channel in use. A physical channel reconfiguration procedure may involve assigning, replacing or releasing a set of physical channels used by the wireless communication device. Therefore, the physical channel reconfiguration may also change the used transport channel type (RRC service state).

The RLC protocol provides segmentation and retransmission services for both user and control data. RLC services in the control plane are signaling radio bearers (SRB). On the user plane, RLC services may be used either by the service-specific protocol layers (packet data convergence protocol (PDCP) or broadcast/multicast control (BMC)) or by other higher-layer functions (e.g., a speech codec). Each RLC instance may be configured by RRC to operate in one of three modes: transparent mode (TM); unacknowledged mode (UM), or acknowledged mode (AM). A sequence number is used as part of a unique identifier for each radio frame using AM or UM RLC mode. Further, sequence numbers provide a mechanism for synchronizing the wireless communication device and the network during an active communication on a first SIM using WCDMA. In particular, an RRC control message may be passed to the RLC layer as a service data unit (SDU), which may be segmented and converted into at least one protocol data unit (PDU). For downlink RRC messages that are sent using unacknowledged mode, such as RRC control messages, a special RLC length indicator may be provided in the first RLC PDU indicating the start of the RLC SDU.

The data types and values used for PDUs in various radio access technologies may be defined by an abstract syntax definition found in the protocol message specification, as well as the encoding rules describing the transfer syntax. The syntax for the data types and values defining each PDU may be provided by the applicable protocol message specification. Together, the abstract syntax notation and encoding rules may provide an abstract definition for PDUs, separate from considerations regarding the bit stream to be transmitted. This approach, which uses ASN.1 basic notation and Packed Encoding Rules (PER), is used in the RRC specification for defining Protocol Data Units (PDU) and Information Elements (IE).

As described, an active communication on the first SIM may be disrupted by a long tune-away period to perform any of a number of idle mode tasks for the second SIM, (e.g., cell selection or reselection, decoding the paging channel, etc.) The duration of the tune-away period may depend on the particular idle mode task and configurations set by the network providing service to the second SIM. For example, the tune-away duration may be between 200 ms and 3 seconds.

During the tune-away period, the wireless communication device (or modem stack associated with a first SIM) may fail to receive part of an RLC PDU sent by the network to deliver information, such as an RRC control message, to the wireless communication device. For example, the wireless communication device may have received one or more RLC PDU prior to tune-away, including the first RLC PDU of a new RLC SDU. Some or all of the remaining RLC PDUs that make up the RLC SDU may be missed during the tune-away period. In another example, the initial portion of the RLC SDU for the RRC message, including the first RLC PDU, may have been missed during the tune-away period. RRC control messages are typically triggered for processes that involve a configuration change in the wireless communication device, and a corresponding change on the wireless network. For example, critical RRC control messages may include instructions to switch between states in the RRC connected mode (e.g., radio bearer reconfiguration, physical channel reconfiguration, etc.).

An RRC control message may provide both the desired configuration change and an activation time that enables the wireless communication device to apply the configuration change at the same time as the network. In a downlink RLC SDU, the activation time supplies a duration to wait after the complete RLC SDU is received before applying the configuration change. In both cases, once the tune-away period is over, the wireless communication device may resume reception of downlink RLC PDUs. For RLC PDUs sent in an acknowledged or unacknowledged mode (e.g., RRC control messages) the wireless communication device may determine that at least one downlink RLC PDU was missed during the tune-away period based on sequence number(s) of received PDU(s).

The wireless communication device may send an uplink status report to the network to request retransmission of the missed PDUs, starting with the first RLC PDU of the SDU if not received prior to the tune-away period. However, until the complete SDU is received, there is a mismatch between the impending configuration change on the network and the lack of corresponding planned configuration change on the wireless communication device. Specifically, while some of the RLC PDUs that were missed may be recovered, the network may implement the new configuration at the activation time before the complete SDU is received by the wireless communication device. Therefore, the wireless communication device loses synchronization with the network in at least one layer managed by RRC.

As described, current wireless procedures impose delays to declaring a radio link failure, thereby delaying the recovery on the network. In particular, the wireless communication device continues to measure the downlink DPCCH until the out-of-sync indicator is detected for a threshold number N313 of consecutive frames (e.g., around 200 frames, 2 seconds). Upon reaching the threshold number N313 of out-of-sync frames, the wireless communication device triggers a countdown timer T313, which may last between about 3 seconds to about 16 seconds depending on the network configuration. Once the countdown timer T313 has expired, the wireless communication device may trigger a radio link failure and perform a cell update procedure.

The triggering of a radio link failure on a wireless communication device (or modem stack associated with a first SIM) due to the loss of physical layer synchronization in the Cell_DCH state may trigger a cell update as part of a procedure to reestablish the active data call. In the call reestablishment procedure, the wireless communication device may switch to a common channel (e.g., Cell_FACH state) and send a cell update message to the network indicating a radio link failure cause. Upon receiving the cell update, the network may delete the existing radio links, setup a new radio link in the serving cell of the wireless communication device, and send a cell update confirm message to the wireless communication device that contains updated configuration information. The wireless communication device may transition to the Cell_DCH state, and send to the network a message that confirms a change made to match the updated configuration information (e.g., transport channel complete, radio bearer setup complete, radio bearer release complete, radio bearer reconfiguration complete, etc.). However, the combined delay resulting from the use of N313 and T313 may be around 5 seconds, but up to around 18 seconds.

In the various embodiments, an early radio link recovery process may be implemented in order to efficiently reestablish the data call using the updated configuration implemented by the network. The early radio link recovery process may involve declaring radio link failure if it is determined that the wireless communication device missed information for implementing a new RRC configuration during the tune-away period, and that the loss of the information requires reestablishing the data call with the network associated with the first SIM. The early radio link recovery process may involve determining whether a modem stack associated with the first SIM received an incomplete RLC SDU from the network. In various embodiments, identifying an incomplete RLC SDU may be based on recognizing a received RLC PDU as the start of a new RLC SDU due to a special length indicator. The wireless communication device may also determine whether the incomplete SDU represents a critical RRC control message for the modem stack associated with the first SIM. In some embodiments, identifying that a critical RRC control message was missed may be based on the syntax of the PDUs of the incomplete SDU that were received by the wireless communication device.

Following the end of the tune-away period, the wireless communication device may identify that a critical RRC control message was missed. The wireless communication device may then start a downlink expiration timer, which may be set to the maximum activation time for RRC reconfiguration. The maximum activation timer may be based on specifications for the network associated with the first SIM, such as 2.56 seconds for example. The wireless communication device may determine whether the downlink expiration timer expires without receiving any downlink PDU for the modem stack associated with the first SIM, and restart the timer if a downlink PDU is received. In this manner, the wireless communication device may ensure that radio link recovery is actually necessary.

Further, the wireless communication device may determine whether a downlink out-of-sync indicator is detected for a selected number of consecutive radio frames. In some embodiments, the selected number may be a factor of the threshold number N313, such as one-fourth of the threshold number N313. For example, if the threshold number N313 is 200 frames, the selected number of consecutive radio frames may be set to 50 frames. In this manner, the wireless communication device may ensure that the wireless communication device has lost system timing synchronization with the network associated with the first SIM. Using the determinations of the early radio link recovery process, a radio link failure may be declared for the modem stack associated with the first SIM when it is determined that the data call must be reestablished. In this manner, the wireless communication device may start a cell update procedure to reestablish the data call on the network associated with the first SIM without the delay typically introduced using the threshold number N313 and T313 timer.

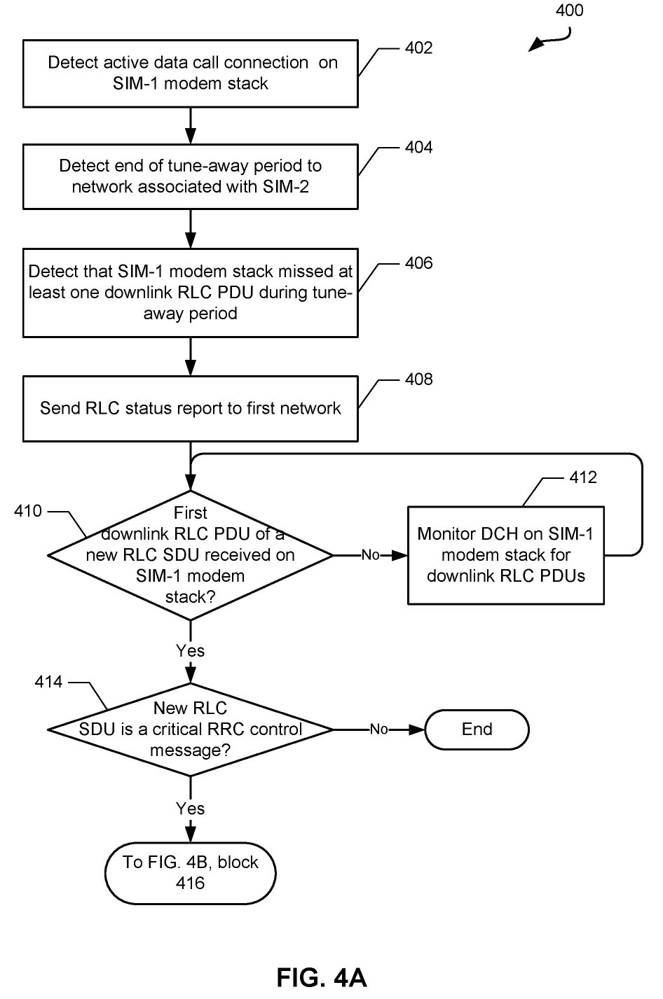

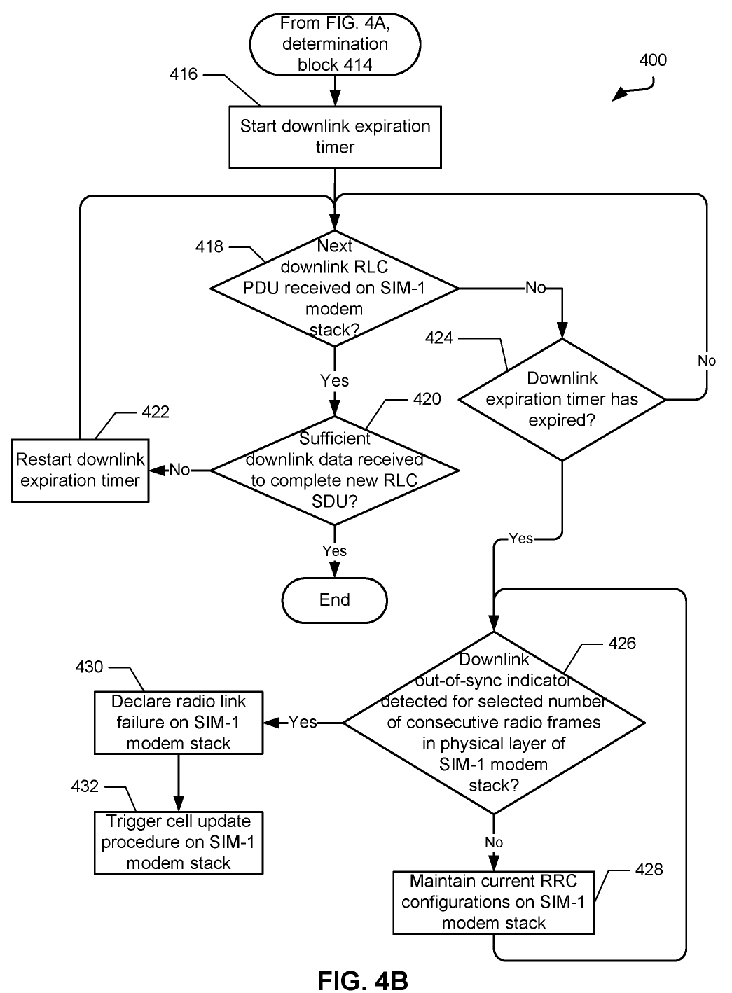

FIGS. 4A and 4B illustrate an example method 400 for efficiently reestablishing an active data call connection between a modem stack associated with a first SIM and a serving network (i.e., “first network”) on a wireless communication device according to various embodiments. Such reestablishment may efficiently recover the radio link for the data call if a tune-away period results in loss of physical layer synchronization with the first network.

With reference to FIGS. 1-4B, the wireless communication device may be an MSMS wireless device (e.g., a DSDS device) that is configured with a single shared RF resource (e.g., 218). In various examples, the operations of the method 400 may be implemented by one or more processors of the wireless device, such as a general purpose processor (e.g., 206) and/or baseband-modem processor (e.g., 216), or a separate controller (not shown) that may be coupled to memory (e.g., 214) and to a baseband-modem processor.

In block 402, the wireless device processor may detect that a modem stack associated with a first SIM (“SIM-1”) is participating in an active data call (e.g., in a Cell_DCH state) on a first network that supports WCDMA. In various embodiments, the modem stack associated with the first SIM may be camped in the first network using a first radio access technology (e.g., WCDMA, HSPA, LTE, etc.), and the modem stack associated with the second SIM may be camped in the second network using a second radio access technology (e.g., GERAN, LTE, WCDMA, etc.). In some embodiments, the first and second networks may be the same network, while in some embodiments the first and second networks may be different networks. In various embodiments, the first network may have assigned dedicated uplink and downlink channels to the modem stack associated with the first SIM in connected mode, while the second SIMs may be in an idle mode.

In block 404, the wireless device processor may detect the end of a tune-away period for the modem stack associated with the second SIM. That is, the wireless device processor may have enabled the modem stack associated with the second SIM to use the RF resource to tune to the second network to perform any of a number of idle mode tasks. For example, the tune-away may allow the modem stack associated with the second SIM to decode a paging channel of the second network, perform a cell selection or reselection, perform a tracking area update (if in an LTE network), etc.

In block 406, the wireless device processor may detect that the modem stack associated with the first SIM missed at least one downlink RLC PDU during the tune-away period. For example, after the tune-away period is over, the wireless communication device may receive one or more downlink RLC PDUs with a sequence number indicating that at least one downlink PDU was missed.

In block 408, the wireless device processor may send an RLC status report to the first network to trigger resending of the one or more downlink RLC PDU that was missed during the tune-away period.

In determination block 410, the wireless device processor may determine whether the first downlink RLC PDU of a new RLC SDU has been received on the modem stack associated with the first SIM. For example, the wireless device processor may identify that an RLC PDU received either before the tune-away period or in response to sending the status report has a length indicator associated with the start of an RLC SDU.

So long as the wireless device processor determines that the first downlink RLC PDU of a new SDU has not been received on the modem stack associated with the first SIM (i.e., determination block 410=“No”), the wireless device processor may monitor a dedicated transport channel (DCH) on the modem stack associated with the first SIM for downlink RLC PDUs in block 412. In various embodiments, such downlink RLC PDUs may include RLC PDUs that were missed during the tune-away period.

In response to determining that the first downlink RLC PDU of a new SDU has been received on the modem stack associated with the first SIM (i.e., determination block 410=“Yes”), the wireless device processor may determine whether the new RLC SDU is a critical RRC control message in determination block 414. For example, the wireless device processor may identify a message type of the new RLC SDU based on syntax used in the identified first RLC PDU. In some embodiments, a critical RRC control message may be, for example, a radio bearer setup message, radio bearer release message, radio bearer reconfiguration message, physical channel reconfiguration message, transport channel reconfiguration message, etc.

In response to determining that the new RLC SDU is not a critical RRC control message (i.e., determination block 414=“No”), the method 400 may end. In response to determining that the new RLC SDU is a critical RRC control message (i.e., determination block 414=“Yes”), the wireless device processor may start a downlink expiration timer in block 416. The value of the downlink expiration timer may be set, for example, to 2.56 seconds.

While the downlink expiration timer is running, the wireless device processor may determine whether a next downlink RLC PDU is received on the modem stack associated with the first SIM in determination block 418.

In response to determining that a next downlink RLC PDU is received on the modem stack associated with the first SIM (i.e., determination block 418=“Yes”), the wireless device processor may determine whether sufficient downlink data has been received to complete the new RLC SDU in determination block 420. That is, the wireless device processor may determine whether all of the missed RLC PDUs have been received.

In response to determining that sufficient downlink data has been received to complete the new SDU (i.e., determination block 420=“Yes”), the method 400 may end.

In response to determining that sufficient downlink data has not been received to complete the new SDU (i.e., determination block 420=“No”), the wireless device processor may restart the downlink expiration timer in block 422, and return to determining whether a next downlink RLC PDU is received on the modem stack associated with the first SIM in determination block 418.

In response to determining that a next downlink RLC PDU is not received on the modem stack associated with the first SIM (i.e., determination block 418=“No”), the wireless device processor may determine whether the downlink expiration timer has expired in determination block 424.

So long as the downlink expiration timer has not expired (i.e., while determination block 424=“No”), the wireless device processor may continue to determine whether a next downlink RLC PDU is received on the modem stack associated with the first SIM in determination block 418.

In response to determining that the downlink expiration timer has expired (i.e., determination block 420=“Yes”), the wireless device processor may determine whether a downlink out-of-sync indicator is detected for a selected number of consecutive radio frames in the physical layer of the modem stack associated with the first SIM in determination block 426. In some embodiments, the selected number of consecutive radio frames may be a factor of the threshold number N313 configured by the first network.

So long as the downlink out-of-sync indicator is not detected for a selected number of consecutive radio frames in the physical layer of the modem stack associated with the first SIM frames (i.e., determination block 426=“No”), the wireless device processor may maintain the current RRC configurations on the modem stack associated with the first SIM in block 428, which may involve the processor taking no action.

In response to determining that a downlink out-of-sync indicator is detected for the selected number of consecutive radio frames in the physical layer of the modem stack associated with the first SIM (i.e., determination block 426=“Yes”), the wireless device processor may declare a radio link failure on the modem stack associated with the first SIM in block 430, and trigger a cell update procedure on the modem stack associated with the first SIM In block 432. Triggering the cell update procedure in this manner based on the operations and determinations in the method 400 enables the wireless device to initiate the procedure to resynchronize with the wireless network with only a brief delay following a tune away that causes the wireless device to lose synchronization with the network. Thus, the various embodiments improve the user experience by minimizing gaps in service that may be caused by tune away events in certain circumstances.

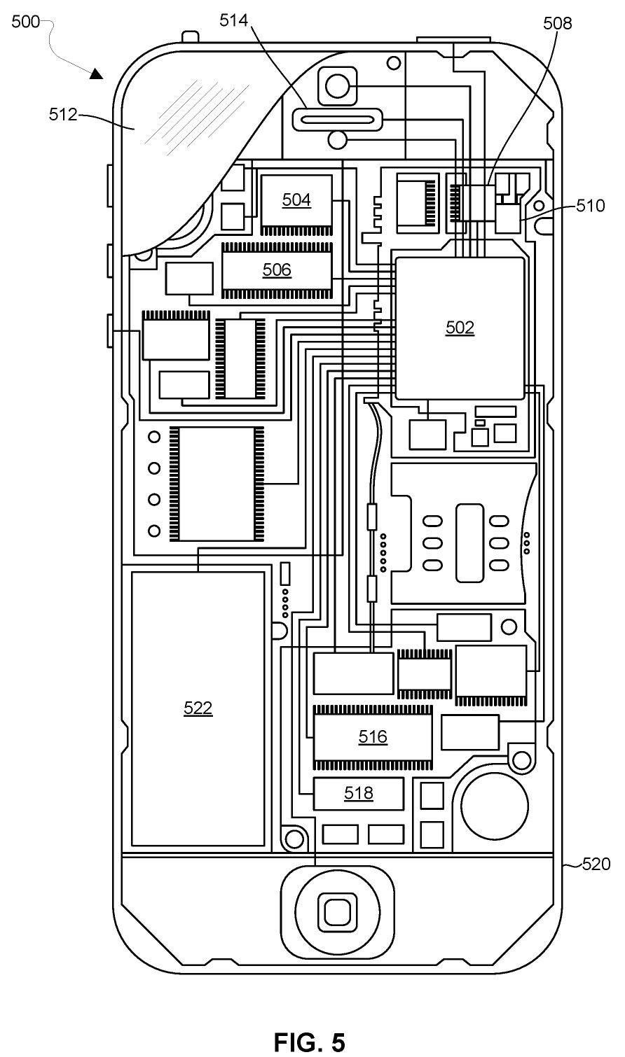

Various examples may be implemented in any of a variety of wireless communication devices, an example of which is illustrated in FIG. 5. For example, With reference to FIGS. 1-5, a wireless communication device 500 (which may correspond, for example, the wireless communication devices 102,200 in FIGS. 1-2) may include a processor 502 coupled to a touchscreen controller 504 and an internal memory 506. The processor 502 may be one or more multicore integrated circuits (ICs) designated for general or specific processing tasks. The internal memory 506 may be volatile or non-volatile memory, and may also be secure and/or encrypted memory, or unsecure and/or unencrypted memory, or any combination thereof.

The touchscreen controller 504 and the processor 502 may also be coupled to a touchscreen panel 512, such as a resistive-sensing touchscreen, capacitive-sensing touchscreen, infrared sensing touchscreen, etc. The wireless communication device 500 may have one or more radio signal transceivers 508 (e.g., Peanut®, Bluetooth®, Zigbee®, Wi-Fi, RF radio) and antennae 510, for sending and receiving, coupled to each other and/or to the processor 502. The transceivers 508 and antennae 510 may be used with the above-mentioned circuitry to implement the various wireless transmission protocol stacks and interfaces. The wireless communication device 500 may include a cellular network wireless modem chip 516 that enables communication via a cellular network and is coupled to the processor. The wireless communication device 500 may include a peripheral device connection interface 518 coupled to the processor 502. The peripheral device connection interface 518 may be singularly configured to accept one type of connection, or multiply configured to accept various types of physical and communication connections, common or proprietary, such as USB, FireWire, Thunderbolt, or PCIe. The peripheral device connection interface 518 may also be coupled to a similarly configured peripheral device connection port (not shown). The wireless communication device 500 may also include speakers 514 for providing audio outputs. The wireless communication device 500 may also include a housing 520, constructed of a plastic, metal, or a combination of materials, for containing all or some of the components discussed herein. The wireless communication device 500 may include a power source 522 coupled to the processor 502, such as a disposable or rechargeable battery. The rechargeable battery may also be coupled to the peripheral device connection port to receive a charging current from a source external to the wireless communication device 500.

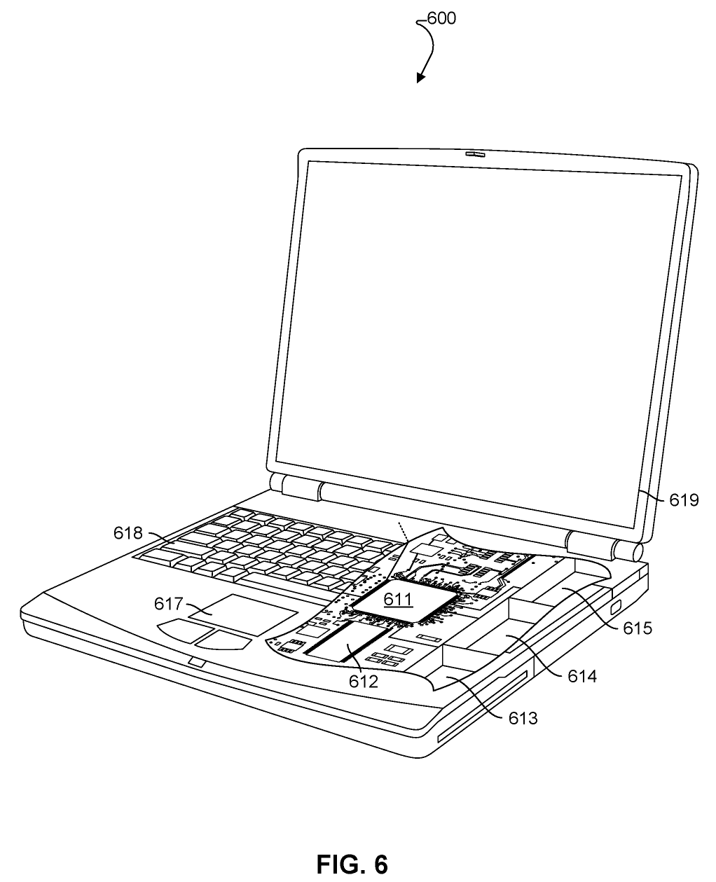

With reference to FIGS. 1-6, various examples described herein may also be implemented within a variety of personal computing devices, such as a laptop computer 600 (which may correspond, for example, the wireless communication devices 102, 200) as illustrated in FIG. 6. Many laptop computers include a touchpad touch surface 617 that serves as the computer's pointing device, and thus may receive drag, scroll, and flick gestures similar to those implemented on wireless computing devices equipped with a touch screen display and described above. The laptop computer 600 will typically include a processor 611 coupled to volatile memory 612 and a large capacity nonvolatile memory, such as a disk drive 613 of Flash memory. The laptop computer 600 may also include a floppy disc drive 614 and a compact disc (CD) drive 615 coupled to the processor 611. The laptop computer 600 may also include a number of connector ports coupled to the processor 611 for establishing data connections or receiving external memory devices, such as a Universal Serial Bus (USB) or FireWire® connector sockets, or other network connection circuits for coupling the processor 611 to a network. In a notebook configuration, the computer housing includes the touchpad touch surface 617, the keyboard 618, and the display 619 all coupled to the processor 611. Other configurations of the computing device may include a computer mouse or trackball coupled to the processor (e.g., via a USB input) as are well known, which may also be used in conjunction with various examples.

The processors 502 and 611 may be any programmable microprocessor, microcomputer or multiple processor chip or chips that can be configured by software instructions (applications) to perform a variety of functions, including the functions of various examples described above. In some devices, multiple processors may be provided, such as one processor dedicated to wireless communication functions and one processor dedicated to running other applications. Typically, software applications may be stored in the internal memory 506, 612 and 613 before they are accessed and loaded into the processors 502 and 611. The processors 502 and 611 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 502, 611, including internal memory or removable memory plugged into the device and memory within the processor 502 and 611, themselves.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various examples to a particular order, sequence, or carrier.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The various illustrative logical blocks, circuits, and algorithm steps described in connection with the examples disclosed herein may be implemented as electronic hardware, computer software, or combinations of both. To clearly illustrate this interchangeability of hardware and software, various illustrative components, blocks, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more examples, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed examples is provided to enable any person skilled in the art to make or use the claims. Various modifications to these examples will be readily apparent to those skilled in the art, and the generic principles defined herein may be applied to other implementations without departing from the scope of the claims. Thus, the claims are not intended to be limited to the examples shown herein but are to be accorded the widest scope consistent with the following claims and the principles and novel features disclosed herein.

What is claimed is:

1. A method of improving performance of a wireless communication device having at least a first subscriber identification module (SIM) and a second SIM associated with a shared radio frequency (RF) resource, the method comprising:
determining whether at least a portion of a critical radio resource control (RRC) control message from a first network supported by the first SIM was missed during a tune-away from an active data call on a modem stack associated with the first SIM to a second network supported by the second SIM; and
in response to determining that at least a portion of a critical RRC control message from the first network was missed during the tune-away:
starting a downlink expiration timer;
determining whether the downlink expiration timer has expired without receiving sufficient information to complete the critical RRC control message;
determining whether the modem stack associated with the first SIM has lost downlink synchronization with the first network for a selected number of consecutive radio frames; and
declaring a radio link failure on the modem stack associated with the first SIM in response to determining that the downlink expiration timer has expired without receiving sufficient information to complete the critical RRC control message, and that the modem stack associated with the first SIM has lost downlink synchronization with the first network for the selected number of consecutive radio frames.

2. The method of claim 1, wherein determining whether at least a portion of a critical RRC control message from the first network was missed during the tune-away comprises:
detecting that at least one downlink radio link control (RLC) packet data unit (PDU) was missed during the tune-away based on one or more out-of-sequence RLC PDUs received on the modem stack associated with the first SIM after the tune-away;
sending a status report message to the first network, wherein the at least one missed downlink RLC PDU is retransmitted by the first network based on the status report message;
identifying, among downlink RLC PDUs received on the modem stack associated with the first SIM, a first RLC PDU of a new RLC service data unit (SDU); and
determining an RRC message type of the new RLC SDU based on a syntax of the identified first RLC PDU.

3. The method of claim 2, wherein identifying the first RLC PDU of a new RLC service data unit (SDU) comprises detecting an RLC header containing a special length indicator in a downlink RLC PDU received from the first network.

4. The method of claim 1, wherein determining whether the modem stack associated with the first SIM has lost downlink synchronization with the first network for a selected number of consecutive radio frames comprises:
determining whether a downlink out-of-sync indicator is successively detected in a physical layer of the modem stack associated with the first SIM for the selected number of radio frames.

5. The method of claim 1, further comprising:
determining whether a downlink RLC PDU is received while the downlink expiration timer is running;
determining whether sufficient information has been received to complete the critical RRC control message for the modem stack associated with the first SIM in response to determining that a downlink RLC PDU is received while the downlink expiration timer is running; and
restarting the downlink expiration timer in response to determining that sufficient information has not been received to complete the critical RRC control message.

6. The method of claim 1, further comprising maintaining a current radio link configuration in response to determining that the modem stack associated with the first SIM has not lost downlink synchronization with the first network for the selected number of radio frames.

7. The method of claim 1, further comprising performing a cell update procedure to reestablish the active data call with the first network in response to determining that the downlink expiration timer has expired without receiving sufficient information to complete the critical RRC control message, and that the modem stack associated with the first SIM has lost downlink synchronization with the first network for the selected number of radio frames.

8. The method of claim 1, wherein a duration of the selected number of consecutive radio frames comprises around 0.5 seconds.

9. The method of claim 1, wherein the downlink expiration timer has a duration of around 2.56 seconds.

10. A wireless communication device, comprising:
a memory;
a shared radio frequency (RF) resource; and
a processor coupled to the memory and the shared RF resource, wherein the processor is configured to connect to at least a first subscriber identity module (SIM) and a second SIM, and wherein the processor is configured with processor-executable instructions to:
determine whether some or all of a critical radio resource control (RRC) control message from a first network supported by the first SIM was missed during a tune-away from an active data call on a modem stack associated with the first SIM to a second network supported by the second SIM; and
in response to determining that some or all of a critical RRC control message from the first network was missed during the tune-away:
start a downlink expiration timer;
determine whether the downlink expiration timer has expired without receiving sufficient information to complete the critical RRC control message;
determine whether a modem stack associated with the first SIM has lost downlink synchronization with the first network for a selected number of consecutive radio frames; and
declare a radio link failure on the modem stack associated with the first SIM in response to determining that the downlink expiration timer has expired without receiving sufficient information to complete the critical RRC control message, and that the modem stack associated with the first SIM has lost downlink synchronization with the first network for the selected number of consecutive radio frames.

11. The wireless communication device of claim 10, wherein the processor is further configured with processor-executable instructions to determine whether some or all of a critical RRC control message from the first network was missed during the tune-away by:
detecting that at least one downlink radio link control (RLC) packet data unit (PDU) was missed during the tune-away based on one or more out-of-sequence RLC PDUs received on the modem stack associated with the first SIM after the tune-away;
sending a status report message to the first network, wherein the at least one missed downlink RLC PDU is retransmitted by the first network based on the status report message;
identifying, among downlink RLC PDUs received on the modem stack associated with the first SIM, a first RLC PDU of a new RLC service data unit (SDU); and
determining an RRC message type of the new RLC SDU based on a syntax of the identified first RLC PDU.

12. The wireless communication device of claim 11, wherein the processor is further configured with processor-executable instructions to identify the first RLC PDU of a new RLC service data unit (SDU) by detecting an RLC header containing a special length indicator in a downlink RLC PDU received from the first network.

13. The wireless communication device of claim 10, wherein the processor is further configured with processor-executable instructions to determine whether the modem stack associated with the first SIM has lost downlink synchronization with the first network for a selected number of consecutive radio frames by:
determining whether a downlink out-of-sync indicator is successively detected in a physical layer of the modem stack associated with the first SIM for the selected number of radio frames.

14. The wireless communication device of claim 10, wherein the processor is further configured with processor-executable instructions to:
determine whether a downlink RLC PDU is received while the downlink expiration timer is running;
determine whether sufficient information has been received to complete the critical RRC control message for the modem stack associated with the first SIM in response to determining that a downlink RLC PDU is received while the downlink expiration timer is running; and
restart the downlink expiration timer in response to determining that sufficient information has not been received to complete the critical RRC control message.

15. The wireless communication device of claim 10, wherein the processor is further configured with processor-executable instructions to maintain a current radio link configuration in response to determining that the modem stack associated with the first SIM has not lost downlink synchronization with the first network for the selected number of radio frames.

16. The wireless communication device of claim 10, wherein the processor is further configured with processor-executable instructions to perform a cell update procedure to reestablish the active data call with the first network in response to determining that the downlink expiration timer has expired without receiving sufficient information to complete the critical RRC control message, and that the modem stack associated with the first SIM has lost downlink synchronization with the first network for the selected number of radio frames.

17. The wireless communication device of claim 10, wherein a duration of the selected number of consecutive radio frames comprises around 0.5 seconds.

18. The wireless communication device of claim 10, wherein the downlink expiration timer has a duration of around 2.56 seconds.

19. A non-transitory processor-readable storage medium having stored thereon processor-executable instructions configured to cause a processor of a wireless communication device configured with a shared radio frequency (RF) resource to perform operations comprising:
determining whether some or all of a critical radio resource control (RRC) control message from a first network supported by a first subscriber identity module (SIM) was missed during a tune-away from an active data call on a modem stack associated with the first SIM to a second network supported by a second SIM; and
in response to determining that some or all of a critical RRC control message from the first network was missed during the tune-away:
starting a downlink expiration timer;
determining whether the downlink expiration timer has expired without receiving sufficient information to complete the critical RRC control message;
determining whether the modem stack associated with the first SIM has lost downlink synchronization with the first network for a selected number of consecutive radio frames; and
declaring a radio link failure on the modem stack associated with the first SIM in response to determining that the downlink expiration timer has expired without receiving sufficient information to complete the critical RRC control message, and that the modem stack associated with the first SIM has lost downlink synchronization with the first network for the selected number of consecutive radio frames.

20. The non-transitory processor-readable storage medium of claim 19, wherein the stored processor-executable instructions are configured to cause the processor of the wireless communication device to perform operations such that determining whether some or all of a critical RRC control message from the first network was missed during the tune-away comprises:
detecting that at least one downlink radio link control (RLC) packet data unit (PDU) was missed during the tune-away based on one or more out-of-sequence RLC PDUs received on the modem stack associated with the first SIM after the tune-away;
sending a status report message to the first network, wherein the at least one missed downlink RLC PDU is retransmitted by the first network based on the status report message;
identifying, among downlink RLC PDUs received on the modem stack associated with the first SIM, a first RLC PDU of a new RLC service data unit (SDU); and
determining an RRC message type of the new RLC SDU based on a syntax of the identified first RLC PDU.
